(19) United States
(12) Patent Application Publication
(10) Pub. No.: US 2013/0036133 A1
(43) Pub. Date: Feb. 7, 2013

(54) System and Method for Providing Data Collection and Comparative Data Analysis Across a Plurality of Gaming Organizations

(71) Applicants: Nicholas Kurt Hogan, RK Leiden (NL); Lucien Maurice Van Linden, EC Maasland (NL)

(72) Inventors: Nicholas Kurt Hogan, RK Leiden (NL); Lucien Maurice Van Linden, EC Maasland (NL)

(21) Appl. No.: 13/430,353

(22) Filed: Mar. 26, 2012

Related U.S. Application Data
(60) Provisional application No. 61/513,991, filed on Aug. 1, 2011.
(60) Provisional application No. 61/605,395, filed on Mar. 1, 2012.

(51) Int. Cl. G06F 17/30

(52) U.S. Cl. 707/769; 707/705; 707/E17.014

(57) ABSTRACT

Systems and methods for collecting variable data received, wherein the variable data relates to gaming operations, such as gaming, hotel, amenities, resort, patron or any other services, transactions and interactions, all occurring in connection with a gaming operation, storing the collected variable data in a database, receiving a request to aggregate the variable data based on an item of information or element associated with the variable data, identifying the variable data in the database based on the element in the request, and presenting the variable data identified if certain preset criteria are met by the requester of data, among other things.

### CROSS-REFERENCE TO RELATED APPLICATIONS

This application claims the benefit of U.S. Provisional Patent Application No. 61/513,991 which was filed Aug. 1, 2011 and U.S. Provisional Patent Application No. 61/605,395 which was filed on Mar. 1, 2012, the disclosures of which are incorporated herein by reference.

### COPYRIGHT NOTICE

A portion of this disclosure contains material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### BACKGROUND

The invention relates to data aggregation and comparative analysis systems and methods for facilitating optimization and revenue generation from gaming operations in a gaming environment such as a casino, gambling hall, pachinko parlor, gaming arcade or online casino, among other things.

### SUMMARY OF THE INVENTION

The invention is generally directed to systems and methods for collecting variable data received, wherein the variable data relates to gaming operations, such as gaming, hotel, amenities, resort, patron or any other services, transactions and interactions, all occurring in connection with a gaming operation; storing the collected variable data in a database; receiving a request to aggregate the variable data based on an item of information or element associated with the variable data; identifying the variable data in the database based on the element in the request; and presenting the variable data identified.

In some embodiments, the step of presenting the variable data associated with the element will not be permitted unless the request is received from a source of variable data received by the system of the invention.

Some embodiments of the invention further include automatically updating the variable data by collecting variable data periodically or upon demand. The collection of data may be facilitated by an application downloaded, installed or otherwise having access to variable data routinely generated in connection with a particular source or gaming operation, and which is capable of transmitting the data for receipt by the system of the invention.

In some embodiments, the source of variable data and any information which may identify the source of variable data is removed or “scrubbed” from the variable data prior to storage or presentment thereof.

In some embodiments, a menu of elements by which the variable data may be aggregated is provided and one or more selected elements are received with the request to aggregate the variable data.

In some embodiments, the variable data includes information regarding gaming operations, and in particular, electronic games on any platform. The variable data may include information such as the types of games, physical and spatial data relating to the gaming floor, locations of games on the gaming floor, meter sets (e.g., coin-in, win, cash-in, games played, etc.), vendor sales information (e.g., market share, ship share, most popular selling games, etc.), configuration information (e.g., variables such as payback, denominations, jackpot hit frequencies, etc.), information that may be submitted to a regulatory body, as well as any other patron interactions with games. The collected variable data may be used to assess trends across multiple gaming locations over time.

The invention is also directed to a method for collecting and providing selective access to industry data, comprising the steps of: receiving a request for data from a user, wherein the requested data is to be retrieved from a collection of data; retrieving information relating to a prior data collection event associated with the user; determining the amount of time between the prior data collection event identified and the request for data received; comparing the amount of time determined with a preset time interval; providing the requested data to the user if the amount of time determined is less than the preset time interval; actuating a data collection event including collecting data from the user if the amount of time determined is not less than the preset time interval or if no data collection event is retrieved; and storing the event of collecting data from the user as the prior collection of data.

In some embodiments, the request for data includes one or more selections of parameters.

In some embodiments, the request for data comprises a preset selection of parameters.

In some embodiments, the aforementioned method further includes the step of receiving identification data relating to a user.

In some embodiments, the preset time interval is dependent on the user or may differ depending on the user or user subscription.

In some embodiments, the information retrieved relating to a prior data collection event includes a time and date of the most chronologically recent prior data collection event in which data was collected from the user.

In some embodiments, the amount of time between the prior data collection event identified and the request for data received is measured in days.

In some embodiments of the aforementioned method, the step of providing the requested data to the identified user if the amount of time determined is less than the preset time interval further includes communicating the requested data over the Internet.

In some embodiments, the aforementioned method further includes the step of querying the user to actuate a data collection event if the amount of time determined is not less than the preset time interval or if no data collection event is retrieved.

In some embodiments, the aforementioned method further includes the step of removing portions of the data collected according to preset criteria.

In some embodiments of the aforementioned method, the step of actuating a data collection event further includes actuating collecting data from a user database and communicating the data to a system database for storing collected data from one or more users.

In some embodiments, portions of the data collected from the user database are removed or changed prior to communicating the collected data to the system database.

In some embodiments, the aforementioned method further includes the step of actuating a data collection event including collecting data from the user if the amount of time determined is equal to the preset time interval.

The invention is also directed to a method for collecting and providing selective access to industry data, which includes the steps of: actuating a data collection event involving collecting user-specific data from a user responsive to the completion of a preset time interval, wherein the data collection event is actuated at the user location; collecting user-specific data from a user database at the user location, wherein the user-specific data includes data relating to business operations conducted by the user during the preset time interval; communicating the collected user-specific data to a system database for storing the user-specific data with data collected from one or more different users; and permitting access to the stored data to the user responsive to the communication of the collected user-specific data to the system database.

In some embodiments, the aforementioned method further includes the steps of: identifying the data among the user-specific data relating to revenue received by the user from a plurality of common sources or activities during the preset time interval completed; and converting the revenue amounts to percentages of total revenue from the plurality of common sources or activities.

In some embodiments, the aforementioned method further includes the step of encrypting the collected user-specific data prior to communicating the collected user-specific data to the system database.

In some embodiments of the aforementioned method, the step of actuating a data collection event involving collecting user-specific data from a user responsive to the completion of a preset time interval is facilitated by software residing on a computer at the location of the user.

In some embodiments, the aforementioned method further includes the step of communicating the collected user-specific data to a system database for storing with data collected from one or more different users involves communication over the Internet.

In some embodiments of the aforementioned method, the step of permitting access to the stored data to the user responsive to the communication of the collected user-specific data to the system database further comprising communicating data from the stored data to the user upon receipt of a request for the data from user.

The invention is also directed to a computer facilitated system which may incorporate various computer components in order to provide the methods as described herein. For example, in some embodiments, a computer facilitated system for collecting and providing selective access to industry data comprising one or more data communication devices, data processors and memory is configured for: receiving a request for data from a user, wherein the requested data is to be retrieved from a collection of stored data; retrieving information relating to a prior data collection event associated with the user; determining the amount of time between the prior data collection event and the request for data received; comparing the amount of time determined with a preset time interval; providing the requested data to the user if the amount of time determined is less than the preset time interval; actuating a data collection event including collecting data from the user if the amount of time determined is not less than the preset time interval or if no prior data collection event is retrieved; and storing the event of collecting data from the user as the prior collection of data.

Some embodiments of the invention are also directed to a non-transitory machine readable media for providing methods as described herein, including one or more software programs, code and/or data segments as necessary to provide any of the methods described herein on one or more computing machines. For example, the aforementioned machine readable media may include: code and data segments configured for actuating a data collection event involving collecting user-specific data from a user responsive to the completion of a preset time interval, wherein the data collection event is actuated at the user location; collecting user-specific data from a user database at the user location, wherein the user-specific data includes data relating to business operations conducted by the user during the preset time interval; communicating the collected user-specific data to a system database for storing the user-specific data with data collected from one or more different users; and permitting access to the stored data to the user responsive to the communication of the collected user-specific data to the system database, among other things.

These and other aspects of the systems and methods of the invention will become more readily apparent to those having ordinary skill in the art from the following description of an exemplary embodiment of the invention taken in conjunction with the accompanying drawings.

### BRIEF DESCRIPTION OF THE DRAWINGS

FIG. 1 is a schematic diagram illustrating the core components of a system constructed in accordance with some embodiments of the invention;

FIG. 2 is a flow diagram illustrating a method configured in accordance with some embodiments of the system;

FIG. 3 is a flow diagram illustrating an additional method configured in accordance with some embodiments of the system;

FIG. 4 is a flow diagram illustrating an additional method configured in accordance with some embodiments of the system;

FIG. 5 is a flow diagram illustrating an additional method configured in accordance with some embodiments of the system; and

FIGS. 6-21 illustrate exemplary login screens, data selection, submittal, retrieval, presentment, visualization, analysis and reporting screens, along with other information regarding exemplary embodiments of the invention.

### DETAILED DESCRIPTION OF EXEMPLARY EMBODIMENTS OF THE INVENTION

In the embodiments described herein, variable data received includes data relating to electronic gaming operations for a plurality of gaming operators. Those skilled in the art will also readily appreciate that such a system configured in accordance with this exemplary embodiment may include or employ various computer and network related software and hardware, such as software and hardware which are used in a distributed computing network, that is, programs, operating systems, memory storage devices, input/output devices, data processors, servers with communication links, wireless or otherwise, such as those which take the form of a local or wide area network, and a plurality of data terminals within the network, such as personal computers and mobile devices. Those skilled in the art will further appreciate that, so long as its users are provided with access to systems and methods constructed in accordance with the invention, specific types of network, software or hardware are not vital to its implementation.

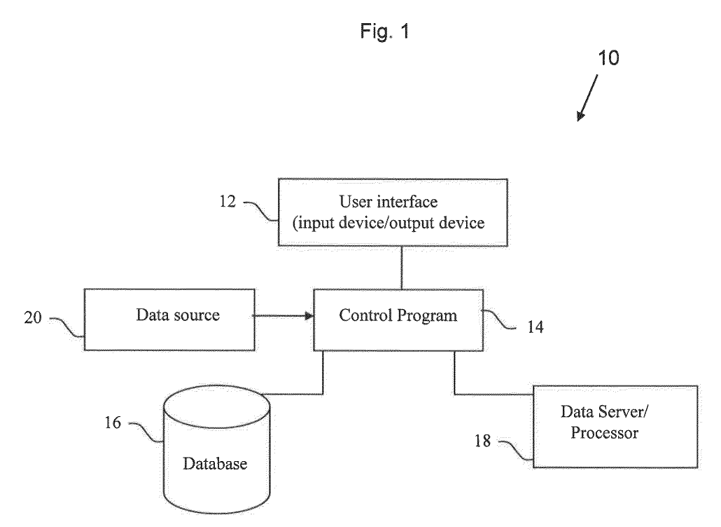

Referring now to the accompanying figures there is illustrated in FIG. 1 a schematic representation of some of the primary functional components of this exemplary embodiment, which is designated generally by reference numeral 10. It should be understood that system 10 may be adapted and configured to function independently or may also interact with other systems or applications, such as for example, a casino management system, or web-based applications commonly used to communicate over the Internet.

In this embodiment, system 10 includes a data input device and data output device, which for purposes of illustration, are collectively referred to as user interface 12. It should be understood that the user interface may actually be composed of differing data input and data output devices. Data provided through user interface 12, including requests or submissions

A control program 14 preferably contains one or more instruction sets or rules which may be written in a conventional computing language such as HTML, C++ or Java, for coordinating the interactive and functional relationship between a data storage device or database 16, a data server or processor 18, and user interface 12. Control program 14 further coordinates and manages variable data collected from a data source 20, such as a gaming operator, for storage in database 16 and functional access thereafter.

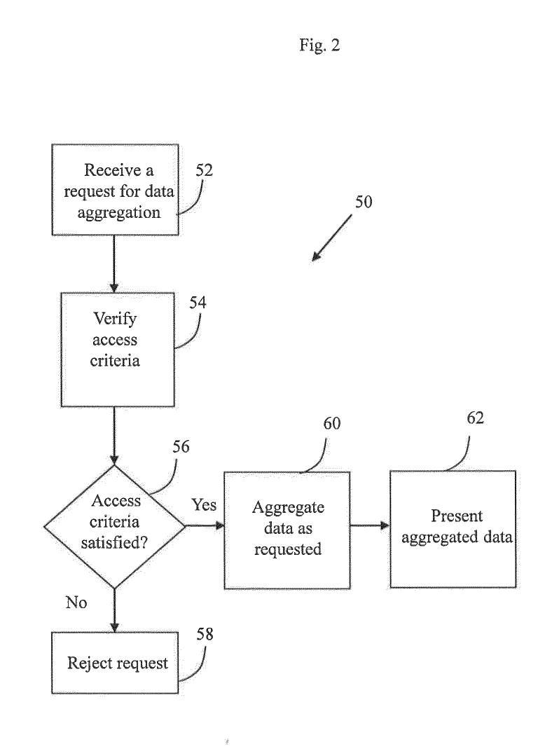

FIG. 2 illustrates a method of this embodiment which is designated generally by reference numeral 50. In step 52, a request is received by system 10 through user interface 12. The request may set forth one or more elements or items of information of interest which will be used by control program 14, in connection with data processor 18, to identify, parse and/or aggregate variable data contained in database 16.

In some embodiments, step 52 is facilitated through presentment of selectable options for data aggregation via user interface 12. For example, a user may select variable data relating to one or more particular game types, game titles, gaming locations or gaming machine manufacturers for aggregation in step 52.

In step 54, system 10 will verify access criteria. As shown by step 56, if access criteria is not satisfied, then the request received in step 52 will be rejected in step 58. If the access criteria is satisfied in step 56, then control program 14, in association with processor 18, will access database 16 and aggregate data in accordance with the request in step 60.

In some embodiments, the access criteria may be verified by requiring the entry of a login and password in user interface 12. The login and password may be compared by control program 14 with a list of approved users in steps 54 and 56. It should be understood that system 10 may be provided to users through payment of a subscription fee, which may be confirmed by system 10 in steps 54 and 56.

Access to system 10 may also be predicated on the submittal of variable data. In other words, a gaming operator or casino (which includes any representatives thereof) wishing to obtain access to the variable data contained in database 16 may be required to transmit or otherwise allow system 10 to collect data relating to their own gaming operations. The status of variable data in database 16 (that is, whether the request received in step 52 has been entered by a user who is also a data source 20 having supplied variable data contained in database 16) may be checked in steps 54 and 56. If the request is received in step 52 by a data source 20 then data may be aggregated as requested in step 60.

If the data is aggregated in step 60 the data may then be presented as shown by step 62 through user interface 12. The data may be presented via user interface 12 in any suitable manner which facilitates its visualization and understanding, such as histograms, graphs, charts, tables, reports, graphical or spatial representations, contour maps, schematic maps with superimposed data, etc. Data may be presented in any statistical manner, such as raw values, percentages, percentiles, comparative results, etc.

It should be further understood that presentation of data in step 62 may consist of the transfer of data through user interface 12, which may be accessed by the user immediately or thereafter. The data may be encrypted by system 10. Alternatively, presenting the data in step 62 may include forwarding a hyperlink through user interface 12 that permits access to the aggregated data as requested which is maintained at a remote location, such as in database 16.

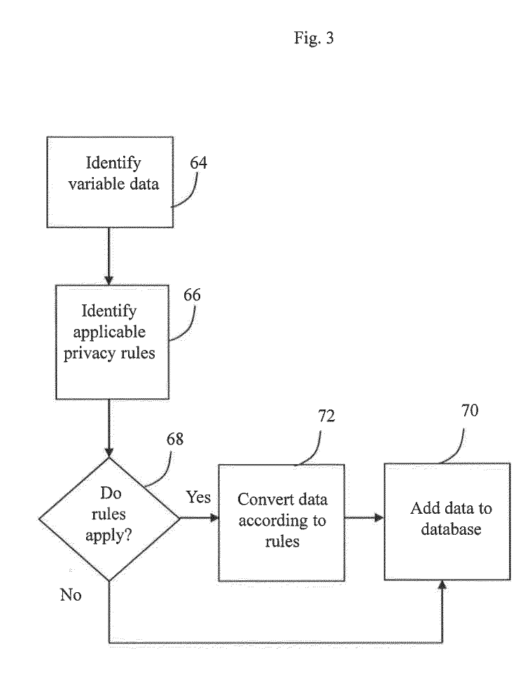

FIG. 3 illustrates an exemplary method by which data is obtained from a data source 20 and added to database 16. It is envisioned that data sources 20 may wish to remove certain information, such as for privacy reasons or otherwise, from any variable data which is collected by system 10.

Some embodiments of the invention may employ an automated application which may reside on the computer system, casino management system or other database operated by a data source 20, or otherwise communicate therewith, for the purpose of facilitating the collection of variable data. Thus, as shown in step 64, system 10 may identify the variable data. The identification may occur periodically. Once the variable data is identified, applicable privacy rules are identified in step 66. If rules do not apply, the variable data will be added to database 16 as shown by steps 68 and 70. If rules do apply, the variable data will be converted or “scrubbed” as described herein and in the accompanying materials as shown by steps 68 and 72 prior to being added to database 16.

The privacy rules may be selected by the data source and maintained by system 10. As the name “privacy rules” suggests, the rules may be set so that certain information is not disclosed by system 10. For example, some gaming operators may not want raw data regarding gaming revenue to be made available to others accessing system 10. Thus, in step 72, the privacy rules identified in step 66 are applied to convert the raw data into something else, such as relative expressions like averages or percentages, such as percentages of the total revenue of the gaming floor for a particular time period. However, the name “privacy rules” should not be construed as a limitation on the types of subjects the rules may address. It should be readily apparent that the rules may apply to other non-privacy related issues relating to the variable data collected. For example, the rules may relate to the timing for data collection, data transfer issues and encryption.

In addition to collecting and providing information regarding gaming operations, some embodiments of the invention facilitate communication between operators and gaming product manufacturers or suppliers, which in turn, may facilitate business transactions between operators and suppliers.

For example, it is envisioned that operators may access system 10 for the purpose of determining the most popular games with players or the games which generate greatest revenue for the operators. System 10 can be used to request data relating to the gaming machines or titles, such as those having the highest “coin-in” values within desired jurisdictional limits, in the manner shown in method 50. System 10 may further provide a selectable option or link for the operator to actuate in order to either receive information, which may be immediately provided from database 16 in some embodiments, or send a request for information regarding a particular gaming product. Information may include any relevant information about the gaming product, such as par sheets. System 10 may further facilitate a transaction between an operator and supplier for a gaming product, or the operator and supplier may conduct the transaction independently, once the interest is communicated from operator to supplier via system 10.

Thus, system 10 may be used by operators to analyze actual performance data, compare gaming products and initiate purchases of gaming products, and by suppliers to provide data which may assist the operators in their analysis and selection of gaming products. It is envisioned that a commission would be paid by suppliers to the proprietor of system 10 for generating interest and inquiries in their gaming products, and potentially offering related facilitation of business transactions.

It is further envisioned that suppliers or manufacturers that desire to participate in this embodiment of system 10 as described herein would be required to provide data for collection by system 10 relating to existing and future gaming products, among other things. For example, suppliers may provide serial numbers and descriptions of products shipped (or other information which enables system 10 to validate data collected from operators). Suppliers may provide industry relevant information, or data to assist in calculating metrics or other useful measures, such as ship share and market share.

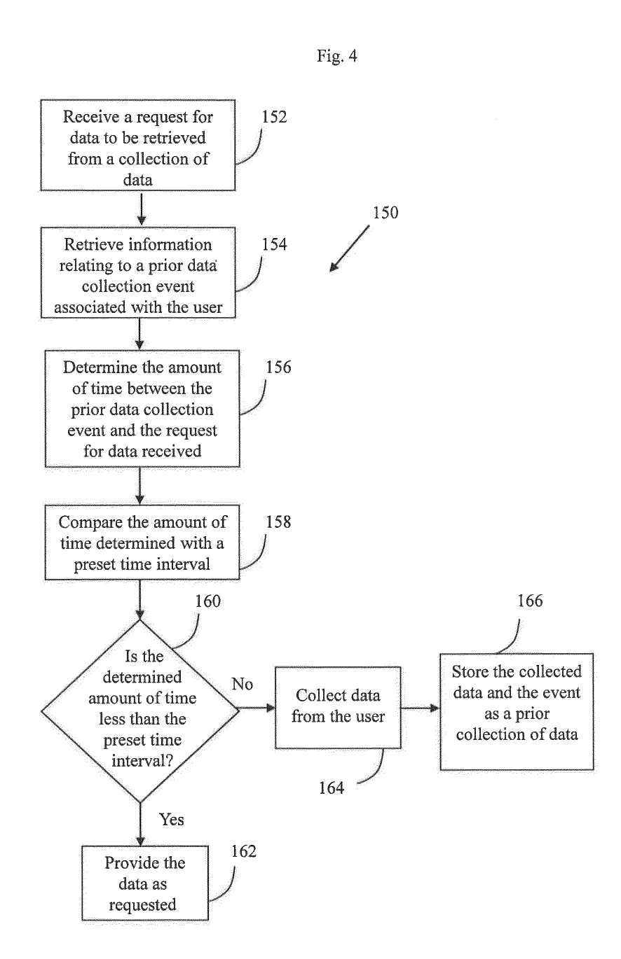

FIG. 4 illustrates another embodiment of the invention for collecting and providing selective access to industry data which is generally referred to by the reference numeral 150. In step 152, a system such as system 10 receives a request for data to be retrieved from a collection of data. In step 154, information relating to a prior data collection event associated with the user is retrieved. The data collection event information may relate to one or more prior collections of data from the user. In step 156, the amount of time between the prior data collection event and the request for data received is determined. In step 158, the amount of time determined is compared with a preset time interval. As shown by step 160, the requested data is provided to the user in step 162 if the amount of time determined is less than the preset time interval, whereas a data collection event including collecting data from the user will be actuated in step 164 if the amount of time determined is not less than the preset time interval or if no data collection event is retrieved and the event of collecting data from the user will be stored as the prior collection of data in step 166.

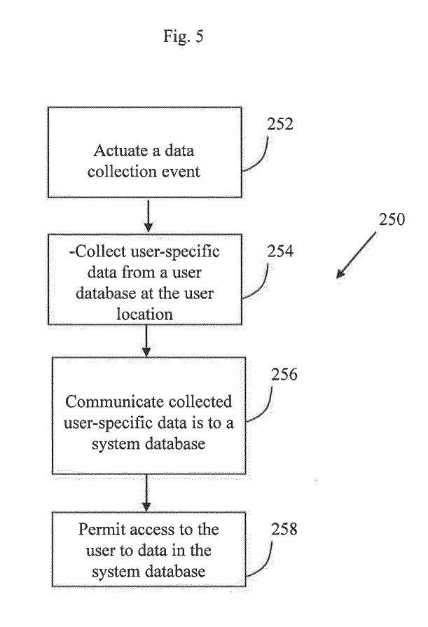

FIG. 5 illustrates another embodiment for collecting and providing selective access to industry data which is generally referred to by the reference numeral 250. In step 252, a data collection event is actuated. In this embodiment, the data collection event involves collecting user-specific data from a user responsive to the completion of a preset time interval, which may include various settings, such as for example, a specific number of days, hours or weeks, or weekly, monthly, bimonthly or otherwise be set to occur on specific days of the month, etc. The data collection event is actuated at the user location or gaming property, which may be from within the user's own computer network.

In step 254, user-specific data is collected from a user database at the user location. The data may be limited to include only the data stored by the user on the user database during the preset time interval completed so that duplicative data is not collected after a baseline amount of data is collected.

In step 256, the collected user-specific data is communicated to a system database, such as database 16, for storing with data collected from one or more different users.

As shown in step 258, the access restrictions to the stored data will be changed so that access is permitted to the user in response to the communication of the collected data to the system database.

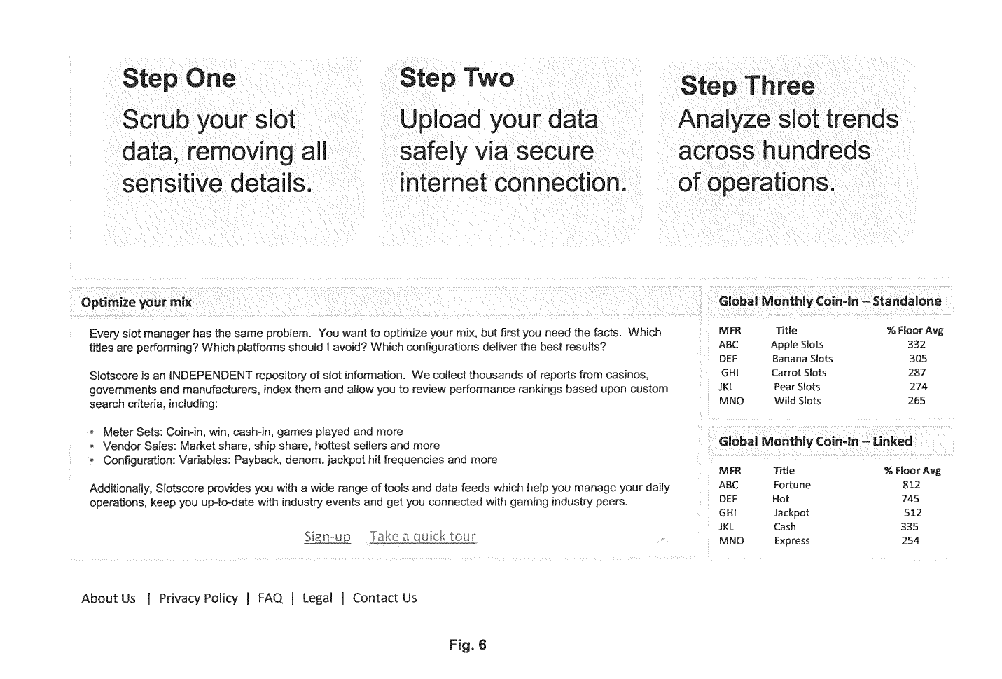

FIGS. 6-21 provide user interfaces configured as graphical user interfaces (also referred to herein as “screens”) which may be presented on a display. Graphical user interfaces which may be employed by some embodiments of a system such as system 10 may generally incorporate user-friendly features and fit seamlessly with other operating system interfaces, that is, in a framed form having borders, multiple folders, toolbars with pull-down menus, embedded links to other screens and various other selectable features associated with animated graphical representations of depressible buttons. These features can be selected (i.e., “clicked on”) by the user via connected mouse, keyboard, or other commonly used tool for indicating a preference in a computerized graphical interface. While FIGS. 6-21 illustrate exemplary login screens, data selection, submittal, retrieval, presentment, visualization, analysis and reporting screens, along with other information regarding exemplary embodiments of the invention, it should be understood that further screens providing more focused or detailed information may be provided. For example, superimposed values over graphical representations of machine banks may be provided.

FIG. 6 illustrates a screen which provides basic information regarding the features of an exemplary embodiment of a system and method of the invention hereinafter also referred to as “Slotscore” or the Slotscore system. As shown in the FIG. 6, Slotscore is described as an independent repository of slot information, which is collected from a variety of sources, including gaming operators, manufacturers/suppliers, and government agencies, for purposes of analyzing slot trends, among other things. The elementary steps of scrubbing slot related data, that is removing any sensitive details, uploading the scrubbed data and being provided with access to all data in the repository for analytical purposes, is disclosed and advertised in the screen shown in FIG. 6.

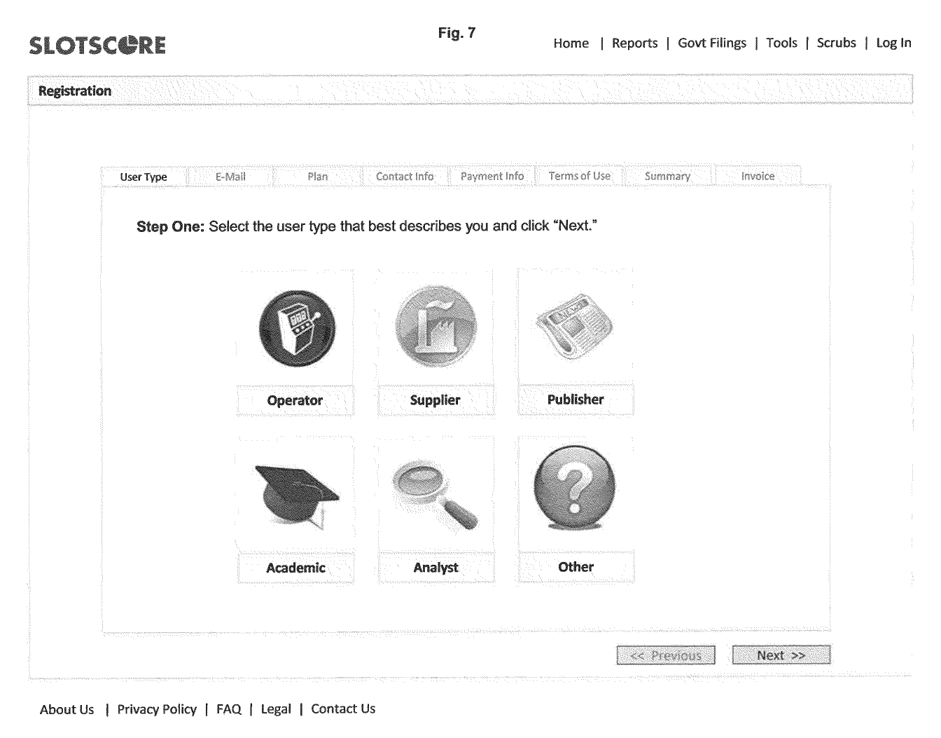

FIG. 7 illustrates an exemplary screen for use in the registration of a new user for Slotscore, which among other things, shows a range of main types of users envisioned, such as operators, suppliers, publishers, academics and analysts.

Once registration is complete, which may include payment and confirmation thereof, users will be provided access. In this embodiment, access to Slotscore will not include the ability to obtain access to data and reports until data is received from the new user. The manner in which this occurs is through a download of a Slotscore scrubber software application. In this embodiment, the Slotscore scrubber software application will review all slot-related data, identify the absolute numbers (such as raw coin-in values), convert the absolute numbers to relative numbers (such as percentages of the floor average or all slot machines available), generate an encrypted, password protected file that may be reviewed by the operator, edited and/or uploaded to Slotscore via a communication network, such as the Internet. Thus, in this embodiment, confidential data relating to revenue is removed prior to transmission of data for inclusion in the Slotscore system.

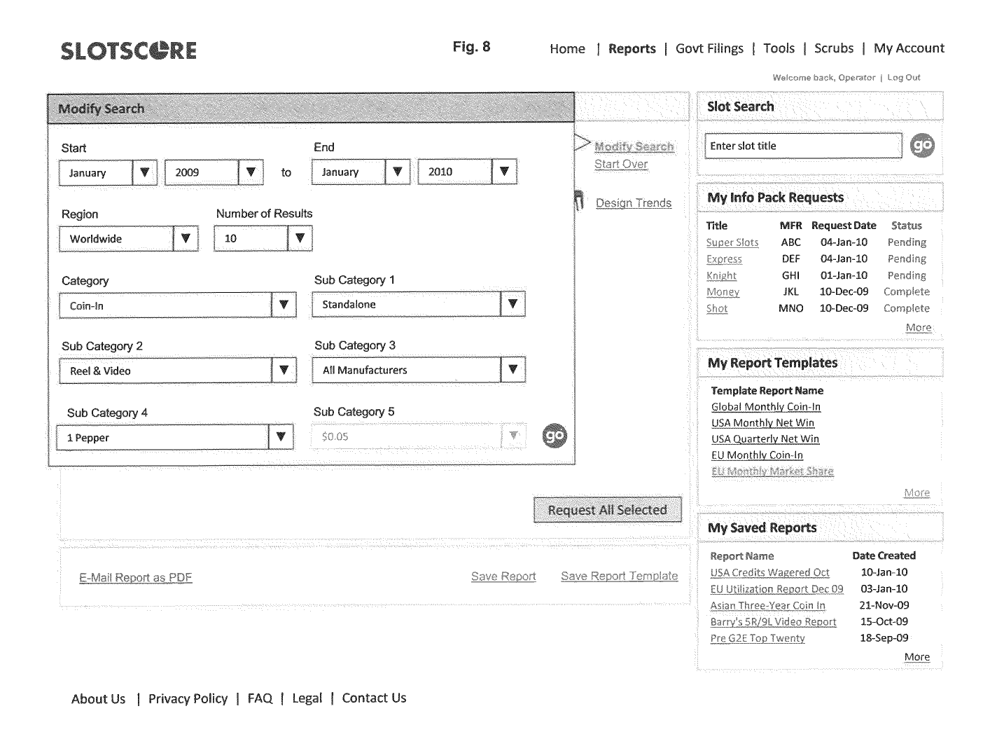

FIG. 8 illustrates a search screen with various options for selecting data for report generation, including date range, region, multiple categories relating to either the slots or slot performance (such as coin-in, hold, machine type, max bet, average bet, manufacturer, display type, platform, etc.) and other analytics, such as a “spice index” (“Sub Category 4”) which is described in greater detail herein.

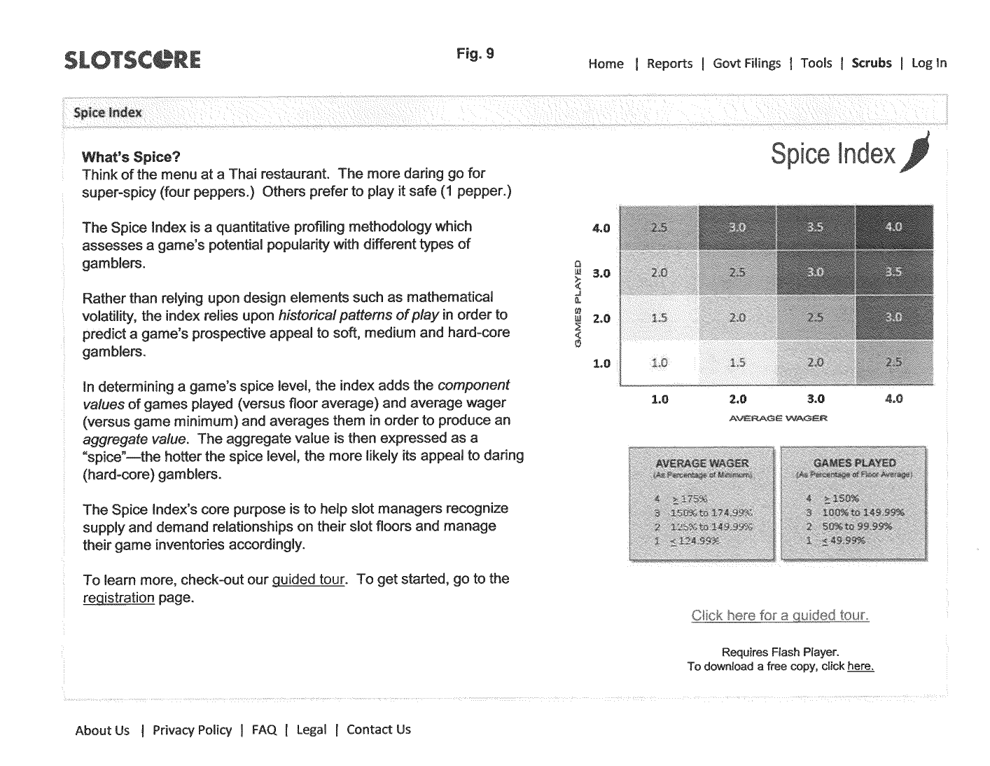

In this embodiment, the spice index is a means by which a game can be cross-referenced with player demographic, and is expressed as a scale ranging from 1 to 4 peppers measuring relationships between average wager and number of games played. Slot games featuring a low average wager and a high number of games are “less spicy” (i.e., lower number of peppers) and popular with casual players who wish to maximize time-on-device. Those slot games featuring high average wagers and low numbers of games are “more spicy” (i.e., higher number of peppers) and popular with harder-core gamblers in pursuit of extreme volatility. The spice index value is in this embodiment expressed and presented as a number of peppers from 1 to four. FIG. 9 illustrates a screen which provides additional information regarding the spice index as used in this embodiment.

The spice index may be particularly helpful because when managing slot machine inventory, operators must remain keenly aware of supply and demand relationships existing between the inventory which they offer and the preferences of patrons who play them. If, for example, an operator's core demographic is dominated by patrons who crave wildly volatile, high-risk/high-reward propositions, the operator would not want to overstock the gaming floor with games featuring very low risk profiles. Rather, the operator attempts to find an equilibrium between game profiles offered and the observed preferences of patrons. Various figures provided herein illustrate screens listing game titles and manufacturers or other information along with a spice index rating presented in terms of peppers on the screen.

To provide useful analytics to its users, Slotscore isolates data elements which indicate most strongly and consistently patron preferences apropos of risk. One element is the average wager versus game minimum wager. When plotted on a spectrum, a history of low average wagers relative to minimum suggests weighted popularity amongst those who wish to minimize financial risk whilst playing the game. Conversely, a history of high average wagers relative to minimum suggest weighted popularity amongst those pursuing enhanced reward in exchange for higher levels of financial risk. Although such disparities, when viewed within the confines of a single operation, may also suggest that minimum wagers are being offered at levels which are either too high or too low, such anomalies can be flattened (through statistical means) when viewed across a plurality of gaming operations.

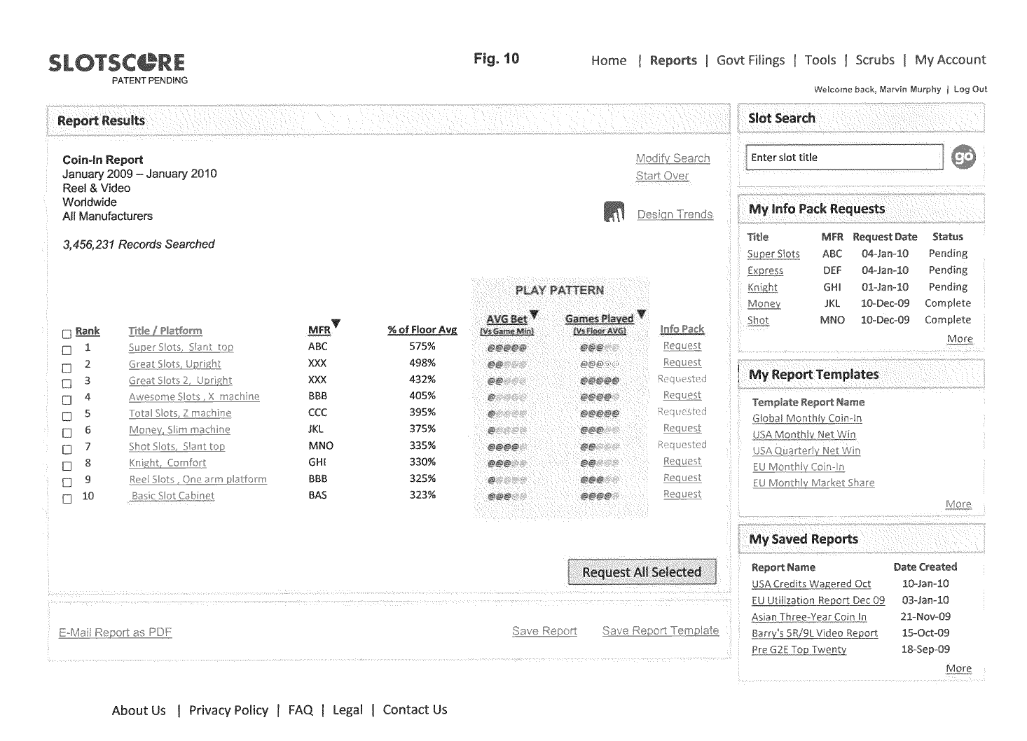

A second data element of interest is games played versus floor average. With this variable, indications of risk are less meaningful when viewed in isolation, but highly meaningful when viewed in conjunction with the game's rank relative to all other titles on-record. In one extreme, a history of low average wager and a low number of games suggests a game which is not only low-risk, but likely unpopular with risk-averse players. As such, it's unlikely that the game will receive a high rank. However, a high-ranking game exhibiting a low average wager and an extremely high number of games suggests strong popularity with the time-on-device player segment. Accordingly, a game with a high-ranking and a history of high average wager and high numbers of games indicates strong popularity with those who prefer a high-risk/high-reward proposition. Third and fourth data points relating to number of lines and credit value are also collected to calculate the game minimum bet. All of the above can assist in determining the play patterns of players, which may differ depending on particular location and during particular days of the week, year or times of day, in order to develop a model that facilitates the selection of the appropriate games on the floor. FIG. 10 illustrates a screen listing play pattern information for various titles and manufacturers along with the parameters as mentioned above. Slotscore may also connect or receive player tracking information to further assess play pattern by actual players and/or other demographic information contained in the player tracking system.

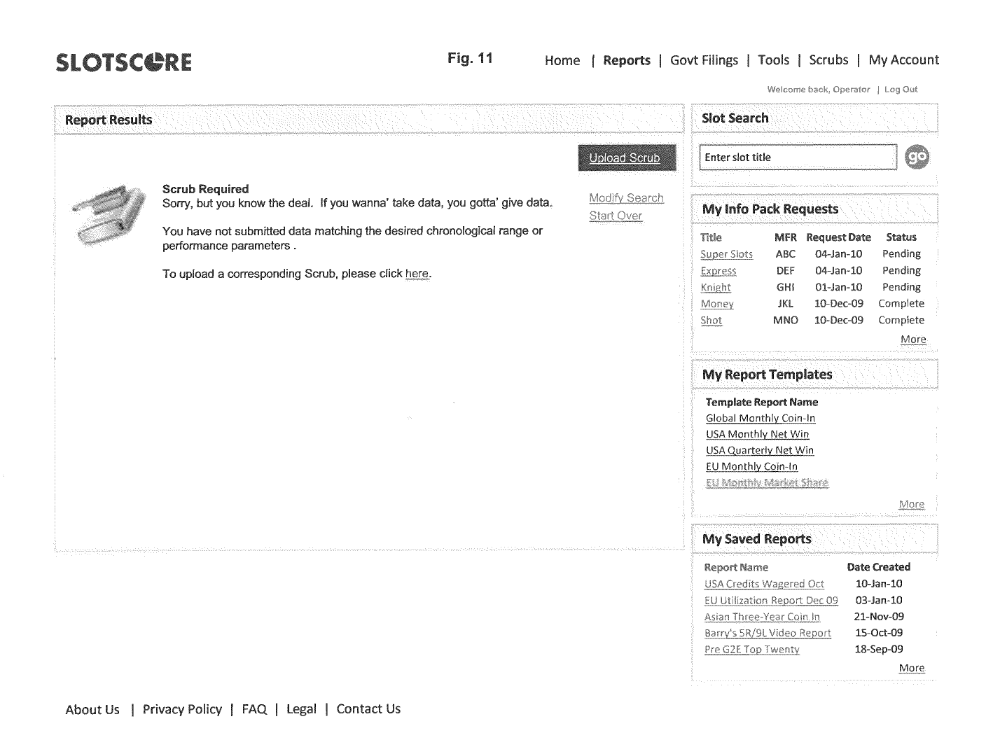

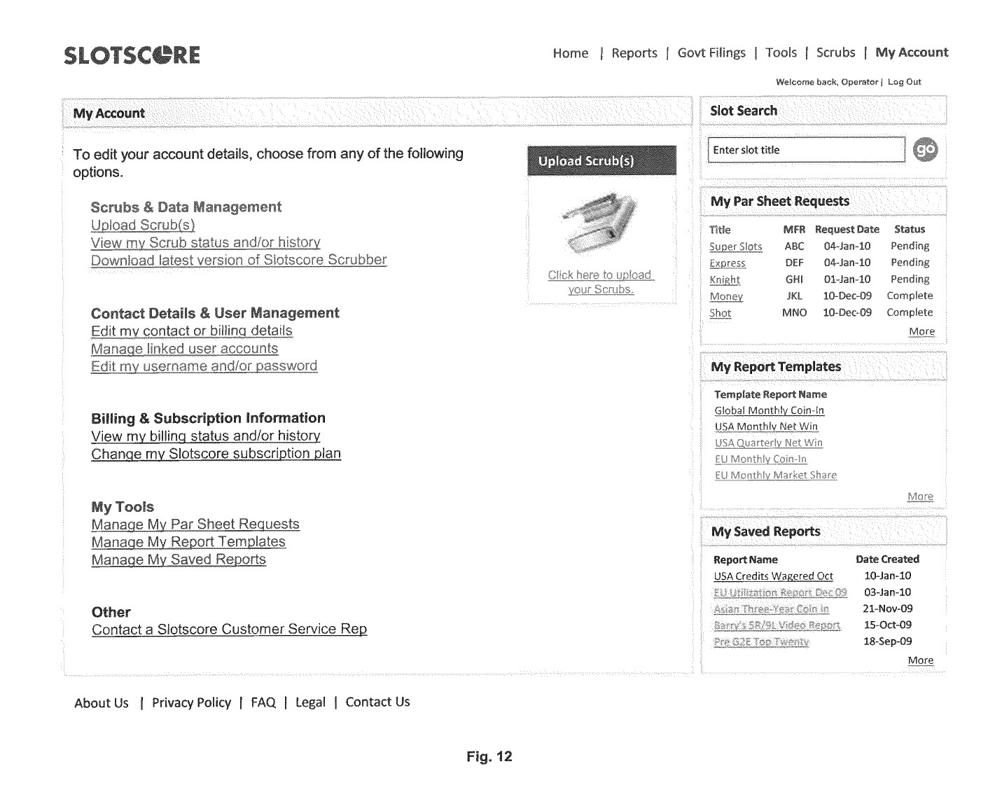

Upon receiving user inputted search selections, the system of the invention will determine whether an upload or exchange of data has occurred. If user data has not been submitted, or if user data has not been submitted within a certain preset range of time or meeting other preset parameters, then a screen such as the screen shown in FIG. 11 will be presented indicating that an upload or “scrub” is needed. It is envisioned that the preset range or parameters may differ depending on the type of user and/or subscription to Slotscore purchased. Presumably the user would run a report or otherwise collect data, scrub the data and then may access a screen such as the screen shown in FIG. 12 to upload scrubbed data. FIG. 12 also illustrates a screen which allows the user to change user account or other information as necessary.

It should be noted that most screens as shown in FIG. 12 among others contain various windows providing additional information and links for report generation or obtaining other data, including preset or user customized report templates, saved reports, and par sheets along with statistics on various user selected game titles and platforms.

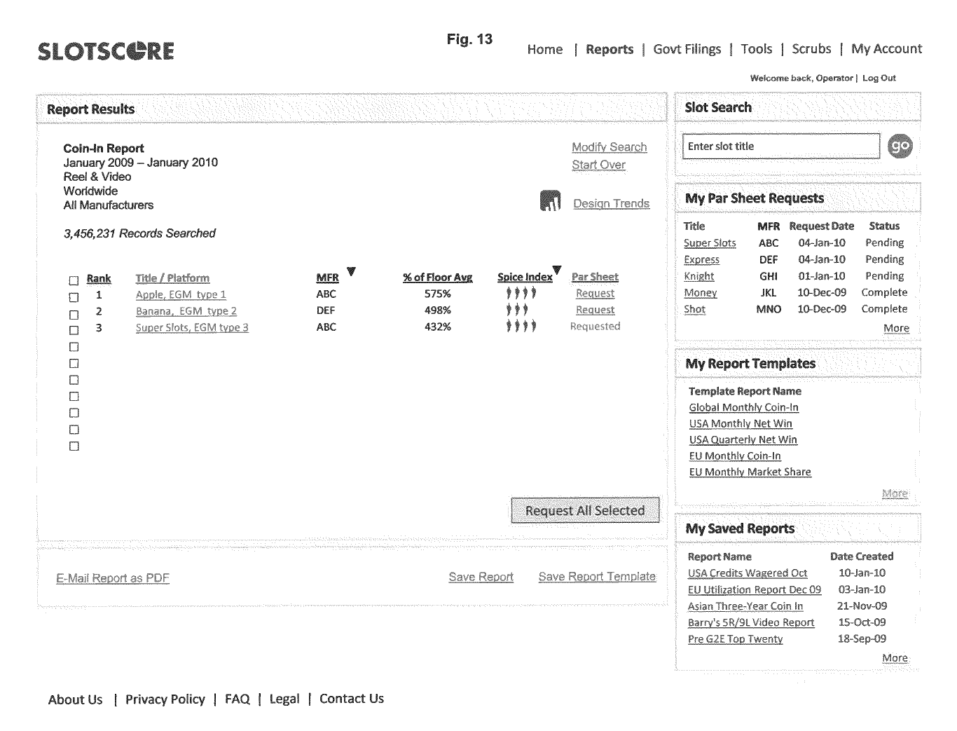

FIG. 13 illustrates a report screen listing the data as selected in the search query screen of FIG. 8, which in this embodiment is entitled a “coin-in” report. While only 3 results are listed in this screen, it should be readily apparent that additional entries may also be listed. Links for requesting par sheets or other additional information are also provided through this screen to facilitate the interest of the user in a potential transaction with the game manufacturer or supplier. As shown in this embodiment, an indication may be provided if such information has already been requested.

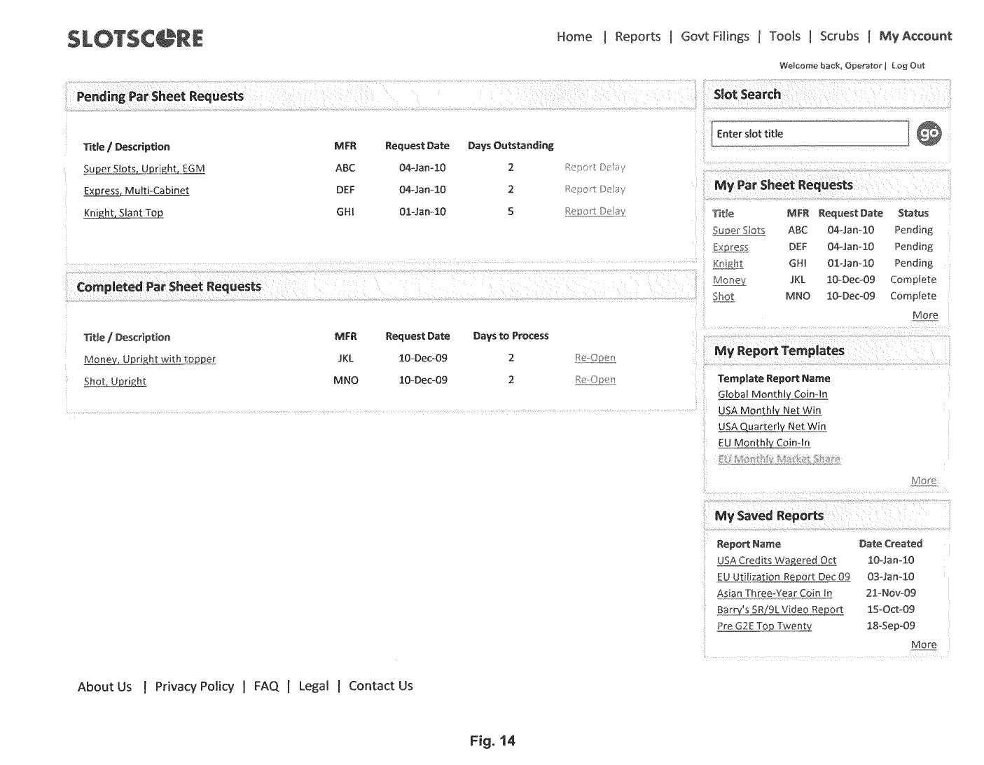

FIG. 14 illustrates an exemplary screen for providing more detailed information on a game title, in this case ABC' s Super Slots game, which may be presented upon selection of the game name link in the screen of FIG. 13, among others. This screen may provide game screenshots and descriptions, risk profile, performance values, volatility, payout, hold, bonus information, user or player ratings and comments, along with other particular information about the game and/or platform.

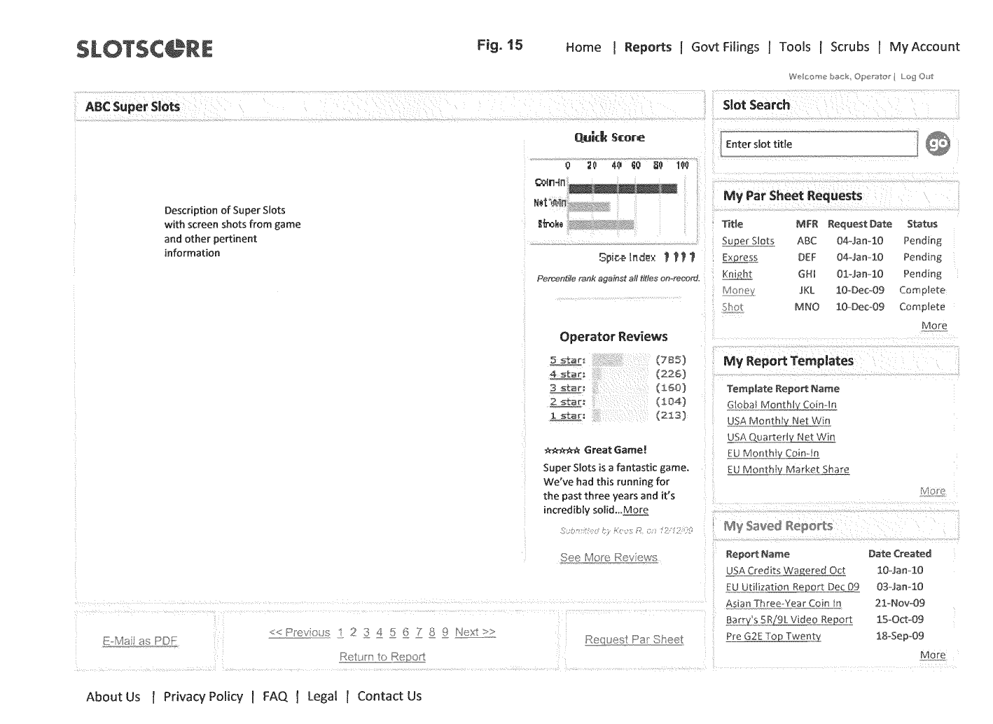

FIG. 15 illustrates an exemplary screen which may be accessed upon requesting additional data or par sheets for a game, which may be via the screen of FIG. 10, among others. Completed par sheets or information requests may be listed along with pending requests. A user may report a delay in receipt of a request through the screen as well.

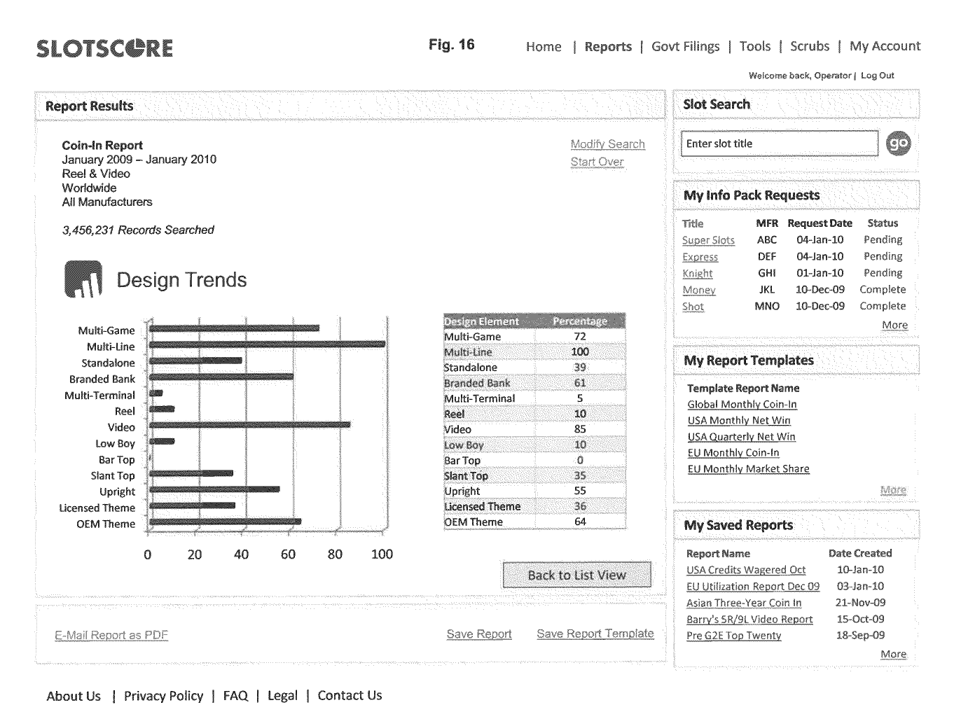

FIG. 16 illustrates a design trend chart which may be accessed through search parameter screen of FIG. 8 and provides various data and statistics relating to the types of machines and games being marketed for parsing as necessary.

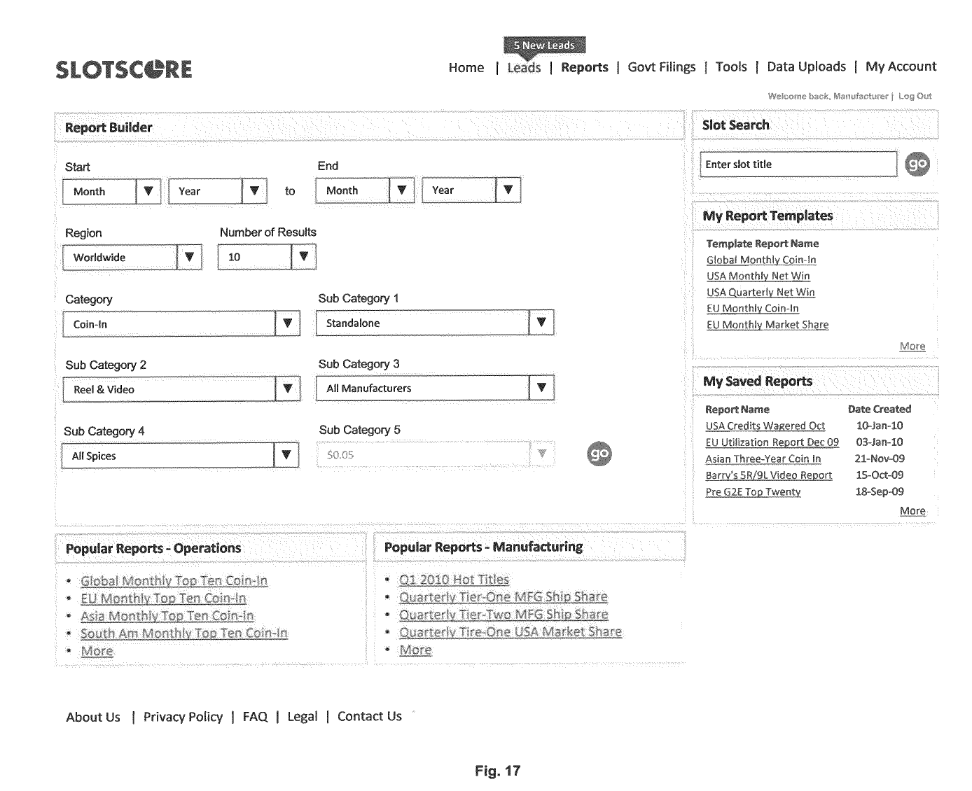

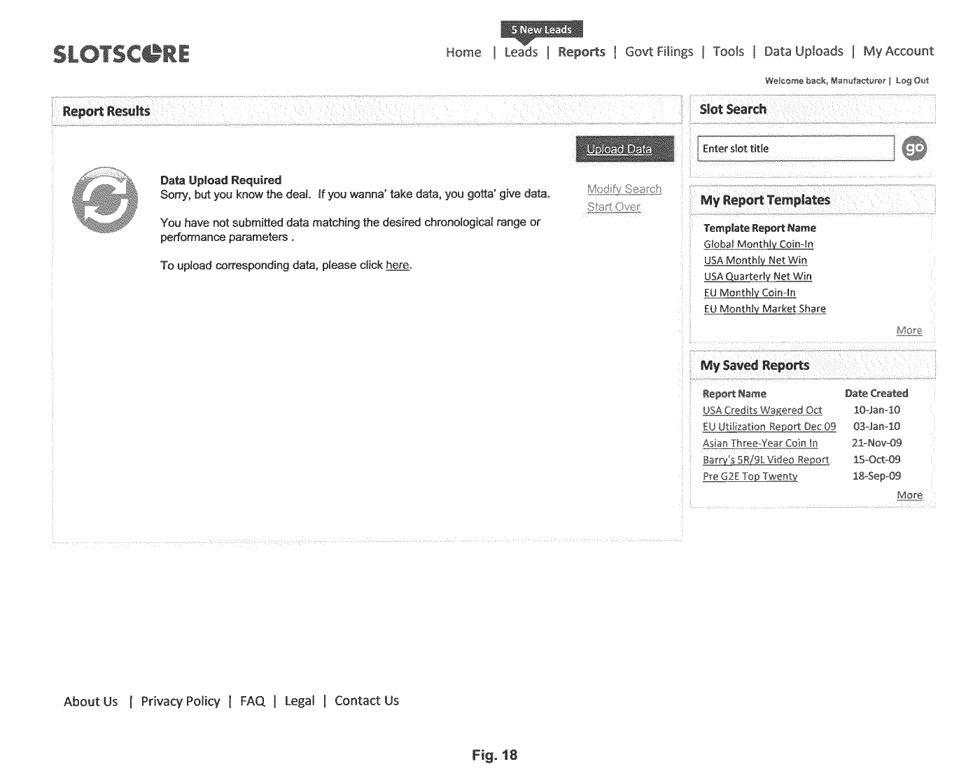

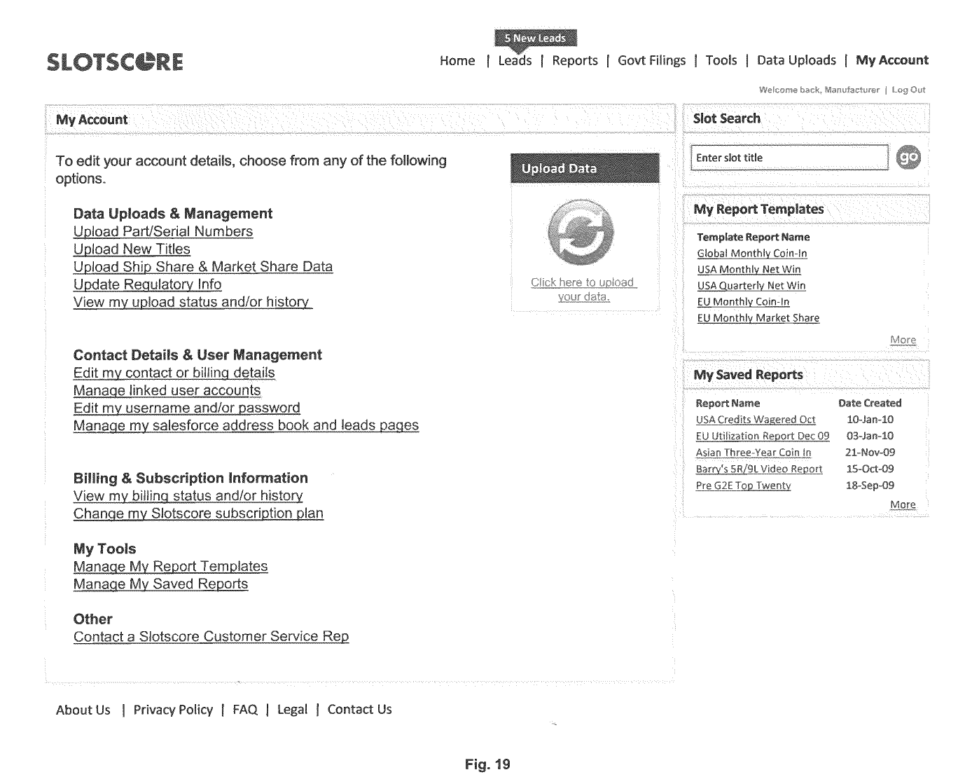

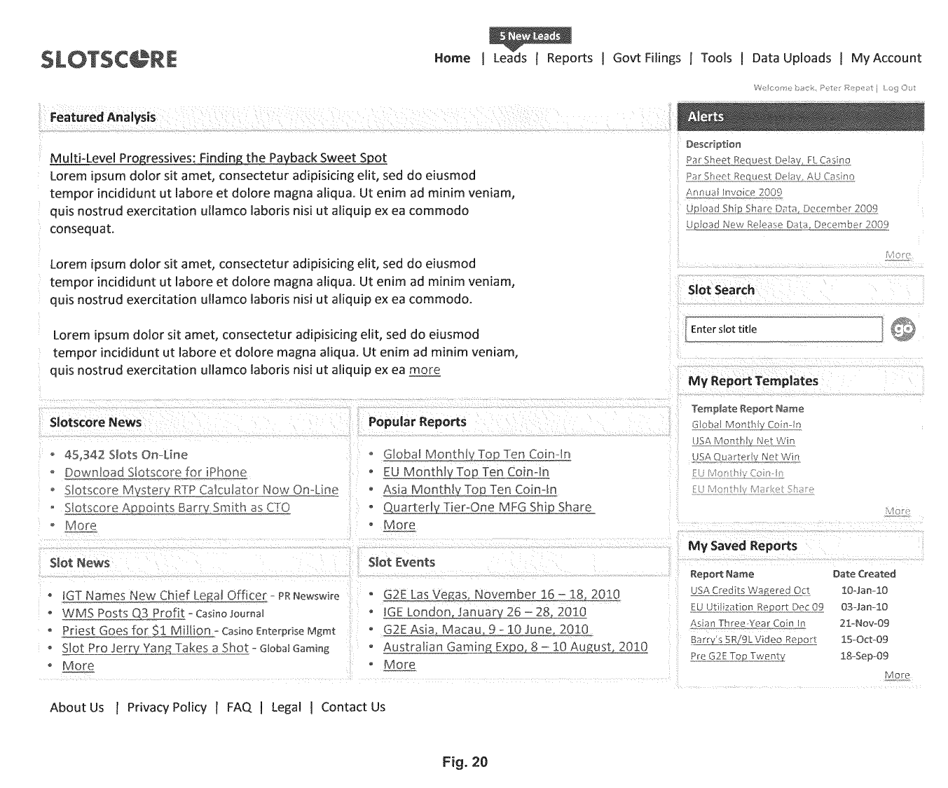

As described above, systems and methods of the invention also are intended to facilitate transactions between operators interested in adjusting their game offerings and manufacturers who supply the games desired. As shown in FIG. 17, a screen graphic indicating “5 leads” can be shown to a manufacturer upon logging into Slotscore. However, manufacturers can be subject to the same requirements for downloading information, such as ship share, new titles and sales information, as operators. If such information is not submitted, a manufacturer may be presented with a screen as in FIG. 18. Manufacturer may access the screen of FIG. 19 in order to facilitate the upload. FIG. 20 illustrates an exemplary screen alerting the manufacture to various par sheet requests and other status information. Slotscore may further provide invoicing services, escrowing services and other sales facilitation to its users.

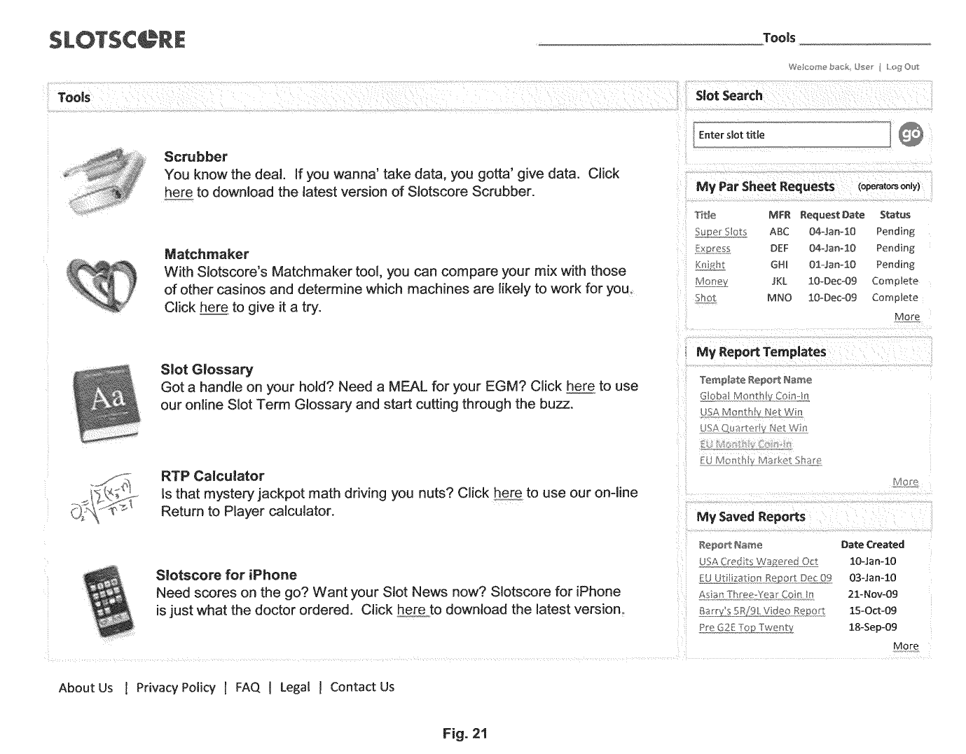

FIG. 21 illustrates various additional information and data analysis available to users of Slotscore, including the ability to compare various data points, such as casinos, games and performance, with those data points and others associated with other gaming operations.

The user may use the information to model or experiment with new layouts and compare the effectiveness of those new layouts with historical layouts. Trend analyses based on data and placement changes of particular gaming machines could be conducted and reviewed to facilitate improved operations and changes.

Slotscore may include message boards focused upon slot management topics, supply/demand analyses using the aforementioned parameters, such as the play pattern and spice index variables or other parameters, operator volatility indexing, which is similar to spice indexing but this is an index which maps the theoretical and actual volatility of individual game titles. Other features may be provided to alert users of new projects, government initiatives, license grants and/or casino expansions, renovations or new builds. Articles of interest in news magazines or website may also be flagged.

The system may also provide direct access to some users to the reporting database for obtaining large data extracts or “data cubes” for analysis with their proprietary tools and models.

In this embodiment, Slotscore is also configured to further provide a marketplace as a transactional platform through which users can sell and/or trade products and/or services to/with other users, including gaming machines and peripherals, professional services, employment advertising, both seeking and hiring, as well as provide social networking aspects.

While exemplary systems and methods in accordance with the invention have been described herein and in the accompanying materials, it should also be understood that the foregoing along with the accompanying materials are illustrative of a few particular embodiments as well as principles of the invention, and that various modifications can be made by those skilled in the art without departing from the scope and spirit of the invention. Therefore, the described embodiments should not be considered as limiting of the invention in any way. Accordingly, the invention embraces alternatives, modifications and variations which fall within the spirit and scope of the invention as set forth in the embodiments provided herein and in the claims, including equivalents thereto.

What is claimed is:

1. A method for collecting and providing selective access to industry data, comprising the steps of:
receiving a request for data from a user, wherein the requested data is to be retrieved from a collection of stored data;
retrieving information relating to a prior data collection event associated with the user;
determining the amount of time between the prior data collection event and the request for data received;
comparing the amount of time determined with a preset time interval;
providing the requested data to the user if the amount of time determined is less than the preset time interval;
actuating a data collection event including collecting data from the user if the amount of time determined is not less than the preset time interval or if no prior data collection event is retrieved; and
storing the event of collecting data from the user as the prior collection of data.

2. A method as recited in claim 1, wherein the request for data includes one or more selections of parameters.

3. A method as recited in claim 1, wherein the request for data comprises a preset selection of parameters for analysis.

4. A method as recited in claim 1, further comprising the step of receiving identification data relating to a user.

5. A method as recited in claim 1, wherein the preset time interval is dependent on the user.

6. A method as recited in claim 1, wherein the information associated with the prior data collection event includes a time and date of the most chronologically recent prior data collection event.

7. A method as recited in claim 1, wherein the amount of time between the prior data collection event identified and the request for data received is measured in days.

8. A method as recited in claim 1, wherein the step of providing the requested data to the identified user if the amount of time determined is less than the preset time interval further comprises communicating the requested data over the Internet.

9. A method as recited in claim 1, further comprising the step of querying the user to actuate a data collection event if the amount of time determined is not less than the preset time interval or if no prior data collection event is retrieved.

10. A method as recited in claim 1, further comprising the step of removing portions of the data collected according to preset criteria.

11. A method as recited in claim 1, wherein the step of actuating a data collection event further comprises actuating collecting data from a user database and communicating the data to a system database for storing collected data from one or more users.

12. A method as recited in claim 11, wherein portions of the data collected from the user database are removed prior to communicating the collected data to the system database.

13. A method as recited in claim 1, further comprising the step of actuating a data collection event including collecting data from the user if the amount of time determined is equal to the preset time interval.

14. A method for collecting and providing selective access to industry data, comprising the steps of:
actuating a data collection event involving collecting user-specific data from a user responsive to the completion of a preset time interval, wherein the data collection event is actuated at the user location;
collecting user-specific data from a user database at the user location, wherein the user-specific data includes data relating to business operations conducted by the user during the preset time interval;
communicating the collected user-specific data to a system database for storing with data collected from one or more different users; and
permitting access to the stored data to the user responsive to the communication of the collected data to the system database.

15. A method as recited in claim 14, further comprising the steps of: identifying data among the user-specific data relating to revenue received by the user from a plurality of common sources or activities during the preset time interval completed; and converting the revenue amounts to percentages of total revenue from the plurality of common sources or activities.

16. A method as recited in claim 14, further comprising the step of encrypting the collected user-specific data prior to communicating the collected data to the system database.

17. A method as recited in claim 14, wherein the step of actuating a data collection event involving collecting user-specific data from a user responsive to the completion of a preset time interval is facilitated by software residing on a computer at the user's facility.

18. A method as recited in claim 14, wherein the step of communicating the collected user-specific data to a system database for storing with data collected from one or more different users involves communication over the Internet.

19. A method as recited in claim 14, wherein the step of permitting access to the stored data to the user responsive to the communication of the collected user-specific data to the system database, further comprising communicating data from the stored data to the user upon receipt of a request for the stored data from the user.

20. A computer facilitated system for collecting and providing selective access industry data comprising one or more data communication devices, data processors and memory for:
receiving a request for data from a user, wherein the requested data is to be retrieved from a collection of stored data;
retrieving information relating to a prior data collection event associated with the user;
determining the amount of time between the prior data collection event and the request for data received;
comparing the amount of time determined with a preset time interval;
providing the requested data to the user if the amount of time determined is less than the preset time interval;
actuating a data collection event including collecting data from the user if the amount of time determined is not less than the preset time interval or if no prior data collection event is retrieved; and
storing the event of collecting data from the user as the prior collection of data.
